(19) United States
(12) Patent Application Publication
(10) Pub. No.: US 2010/0309914 A1
(43) Pub. Date: Dec. 9, 2010

(54) ROUTER AND DATAGRAM MULTICASTING METHOD

(75) Inventors: YANG BAI, Shanghai (CN); ZHEN-FA MIN, Shanghai (CN)

Correspondence Address: Altis Law Group, Inc.;ATTN: Steven Reiss, 288 SOUTH MAYO AVENUE, CITY OF INDUSTRY, CA, 91789, US

(73) Assignees: AMBIT MICROSYSTEMS (SHANGHAI) LTD., SHANGHAI (CN); HON HAI PRECISION INDUSTRY CO., LTD., Tu-Cheng (TW)

(21) Appl. No.: 12/723,677

(22) Filed: Mar. 14, 2010

(30) Foreign Application Priority Data
Jun. 5, 2009 (TW) 98118861

(51) Int. Cl. H04L 12/56

(52) U.S. Cl. 370/390; 370/401

(57) ABSTRACT

A router includes a wide area network (WAN) interface, a switch circuit, and a driver. The WAN interface receives a multicast datagram from a multicast server and sends the multicast datagram to the switch circuit and the driver. The switch circuit obtains ports corresponding to a multicast address of the multicast datagram according to a switching table of the router, and distributes the multicast datagram to the obtained ports. The driver obtains interfaces corresponding to the multicast address of the multicast datagram according to a multicasting table of the router. The driver discards the multicast datagram if all the obtained interfaces are wired or multicasts the multicast datagram to the wireless interface if one of the obtained interfaces is the wireless interface.

### BACKGROUND

1. Technical Field

Embodiments of the present disclosure relate to routers, and more particularly to a router and a datagram multicasting method thereof.

2. Description of Related Art

Multimedia applications, such as streaming media, video conference, video on demand, are widely employed on the Internet. Using unicast technology, a router unicasts datagrams from a unicast server to receivers peer to peer, and is required to duplicate each datagram for each receiver, causing the router to be exhausted because of the repeated duplication. Therefore, the unicast technology is not suitable for those multimedia applications. The multimedia applications require the router multicasting datagrams from one multicast server to multiple receivers. The multicast server is merely required to duplicate each datagram one time for all receivers, which improves efficiency of datagram transmission. Therefore, the multicast technology is available for those multimedia applications and, nowadays, has been widely employed in the Internet.

A technology called Internet group management protocol (IGMP) proxy is employed in a router for directing a driver to distribute the multicast datagrams. The IGMP proxy generates relationships between a multicast group and an interface when the router receives a request from a terminal connected to the interface to join the multicast group and directs the driver to distribute multicast datagrams belonging to the multicast group to the corresponding interface. However, if the interface is wired and corresponds to one or more communication ports connecting to one or more terminals, the multicast datagrams are transmitted to all the one or more communication ports, which unnecessarily wastes bandwidth of other terminals.

To overcome the bandwidth waste, a technology called IGMP snooping is employed in the router for directing a switch application specific integrated circuit (ASIC) in the router to distribute the multicast datagrams to corresponding ports. The IGMP snooping generates relation between a multicast group and a port when the router receives a request from a terminal connected to the port to join the multicast group. Therefore, the switch ASIC merely distributes a multicast datagram belonging to the multicast group to the corresponding port.

The driver is computer-readable software, and the switch ASIC is hardware. Subsequently, the driver requires much more time to route a multicast datagram than that of the switch ASIC. When the multicast datagrams received from wide area network are merely required by the wired interface, the driver still routes the multicast datagrams, which decreases multicast throughput of the router.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a router of the present disclosure;

FIG. 2 is a schematic diagram of one embodiment of a multicasting table of FIG. 1 of the present disclosure;

FIG. 3 is a schematic diagram of one embodiment of a switching table of FIG. 1 of the present disclosure; and

FIG. 4 is a flowchart of one embodiment of a datagram multicasting method of the present disclosure.

### DETAILED DESCRIPTION

All of the processes described may be embodied in, and fully automated via, software code modules executed by one or more general purposes computers or processors. The code modules may be stored in any type of computer-readable medium or other storage device. Some or all of the methods may alternatively be embodied in specialized computer hardware or communication apparatus.

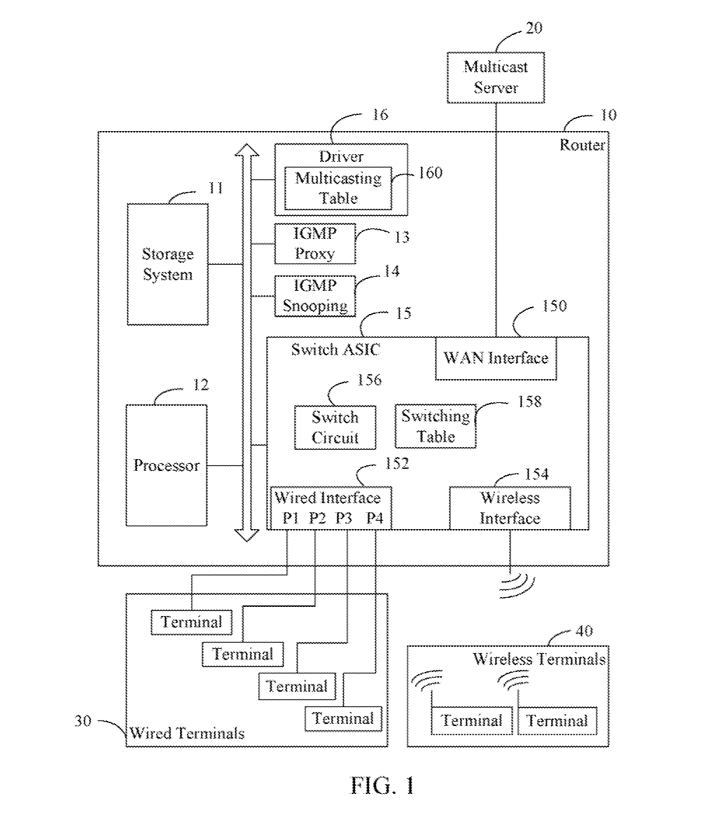

FIG. 1 is a schematic diagram of an application environment and functional modules of one embodiment of a router 10 of the present disclosure. The router 10 includes an upstream interface, such as a wide area network (WAN) interface 150, and a plurality of downstream interfaces, such as a wired interface 152 and a wireless interface 154. The wired interface 152 usually corresponds with one or more communication ports, such as P1, P2, P3, and P4, which are respectively connected to wired terminals 30. The wireless interface 154 connects to wireless terminals 40.

The infrastructure of the router 10 includes software and hardware. In one embodiment, the software includes an Internet group management protocol (IGMP) proxy 13, an IGMP snooping 14, a driver 16, and one or more computerized instructions stored in the storage system 11 and is executed by the at least one processor 12. The storage system 11 may include one or more random access memories (RAM), such as a static RAM (SRAM), a dynamic RAM (DRAM), or an electrically erasable programmable read-only memory (EEPROM).

The hardware includes a switch application specific integrated circuit (ASIC) 15. The WAN interface 150, the wired interface 152, and the wireless interface 154 are all embedded in the switch ASIC 15. The switch ASIC 15 further includes a switch circuit 156.

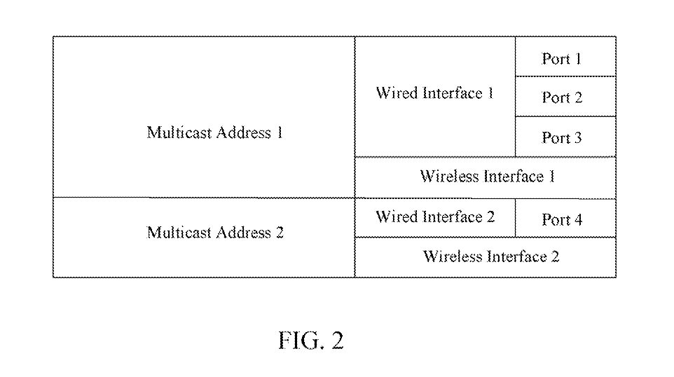

The IGMP proxy 13 establishes a multicasting table 160 for directing the driver 16 to route multicasting datagrams to the wired interface 152 and the wireless interface 154. FIG. 2 is a schematic diagram of one embodiment of the multicasting table 160 of FIG. 1 of the present disclosure. In one embodiment, the multicasting table 160 includes a plurality of multicasting addresses and corresponding wired and wireless interfaces. The driver 16 routes the multicasting datagrams to the wired and/or wireless interfaces corresponding to multicasting addresses of the multicasting datagrams according to the multicasting table 160.

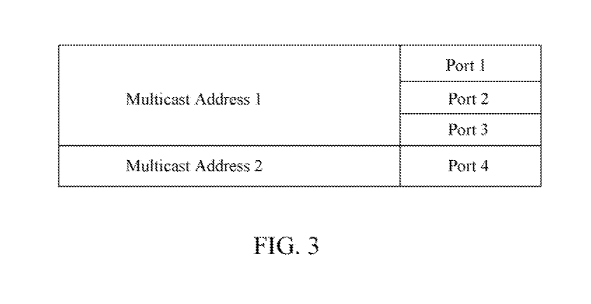

The IGMP snooping 14 establishes a switching table 158 for directing the switch ASIC 15 to distribute the multicasting datagrams to the wired interface 152. FIG. 3 is a schematic diagram of one embodiment of the switching table 158 of FIG. 1 of the present disclosure. In one embodiment, the switching table 158 includes a plurality of multicast addresses and corresponding ports. The switch ASIC 15 distributes the multicast datagrams to the ports corresponding to multicast addresses of the multicast datagrams according to the switching table 158.

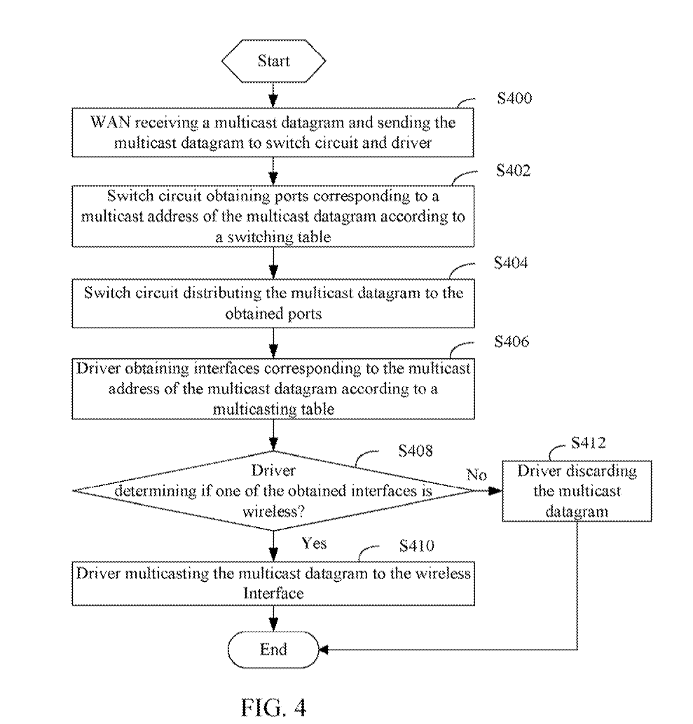

FIG. 4 is a flowchart of one embodiment of a datagram multicasting method of the router 10 of FIG. 1 of the present disclosure. The method may be embodied in the router 10, and is executable by the functional modules such as those of FIG. 1.

In block S400, the WAN interface 150 receives a multicast datagram and sends the multicast datagram to the switch circuit 156 and the driver 16. The multicast datagram includes a multicast address.

In block S402, the switch circuit 156 obtains ports corresponding to the multicast address of the multicast datagram according to the switching table 158. For example, if the multicast datagram includes multicast address 1 shown in FIG. 3, the switch circuit 156 obtains P1, P2, and P3. If the multicast datagram includes multicast address 2 shown in FIG. 3, the switch circuit 156 obtains P4. If the multicast address of the multicast datagram is not included in the switching table 158, that is the switch circuit 156 cannot obtain ports corresponding to the multicast address of the multicast datagram according to the switching table 158, the switch circuit 156 discards the multicast datagram.

In block S404, the switch circuit 158 distributes the multicast datagram to the obtained ports. For example, if the obtained ports are P1, P2, and P3, the switch circuit 156 distributes the multicast datagram respectively to P1, P2, and P3 and then to the corresponding wired terminals 30.

In block S406, the driver 16 obtains interfaces corresponding to the multicast address of the multicast datagram according to the multicasting table 160. For example, if the multicast datagram includes multicast address 1 shown in FIG. 2, the driver 16 obtains wired interface 1 and wireless interface 1. If the multicast datagram includes multicast address 2 shown in FIG. 2, the driver 16 obtains wired interface 2 and wireless interface 2. If the multicast address of the multicast datagram is not included in the multicasting table 160, that is the driver 16 cannot obtain interfaces corresponding to the multicast address of the multicast datagram according to the multicasting table 160, the driver 16 discards the multicast datagram.

In block S408, the driver 16 determines if one of the obtained interfaces is the wireless interface 154. If one of the interfaces is the wireless interface 154, that is not all the obtained interfaces are the wired interface 152, then in block S410, the driver 16 multicasts the multicast datagram to the wireless interface 154. If all the obtained interfaces are wired interfaces 152, then in block S412, the driver 16 discards the multicast datagram.

The switch ASIC 15 of the router 10 of the present disclosure distributes the multicast datagrams before the driver 16 routes the multicast datagrams. The driver 16 only requires routing the multicast datagrams that are required by the wireless interface 154. The multicast datagrams, which are merely required by the wired interface 152, are not required being routed by the driver 16. The driver 16 is software and requires much more time to route a multicast datagram than that of the switch ASIC 15 which is hardware. Therefore, the datagram multicasting method of the present disclosure excessively improves the multicast throughput of the router 10.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A router in communication with a multicast server, the router comprising a processor, a storage system, a switch application specific integrated circuit (ASIC), and one or more programs, wherein the switch ASIC comprises a wired interface corresponding to one or more communication ports, a wireless interface, a wide area network (WAN) interface, and a switch circuit, and the one or more programs are stored in the storage system and operable to be executed by the processor and comprise:
an Internet group management protocol (IGMP) proxy operable to establish a multicasting table comprising multicast addresses and corresponding interfaces, wherein the corresponding interfaces comprise the wired interface and the wireless interface;
an IGMP snooping operable to establish a switching table comprising the multicast addresses and corresponding ports, wherein the WAN interface is operable to receive a multicast datagram comprising a multicast address from the multicast server, and the switch circuit is operable to receive the multicast datagram from the WAN interface and obtain ports corresponding to the multicast address of the multicast datagram according to the switching table and further to distribute the multicast datagram to the obtained ports; and
a driver operable to receive the multicast datagram from the WAN interface, to obtain interfaces corresponding to the multicast address of the multicast datagram according to the multicasting table, to determine if one of the obtained interfaces is the wireless interface, and further to discard the multicast datagram if all the obtained interfaces are the wired interface, or to multicast the multicast datagram to the wireless interface if one of the obtained interfaces is the wireless interface.

2. The router as claimed in claim 1, wherein the switch circuit is further operable to discard the multicast datagram upon the condition that the switch circuit cannot obtain ports corresponding to the multicast address of the multicast datagram according to the switching table.

3. The router as claimed in claim 1, wherein the driver is further operable to discard the multicast datagram upon the condition that the driver cannot obtain interfaces corresponding to the multicast address of the multicast datagram according to the multicasting table.

4. A datagram multicasting method of a router in communication with a multicast server, the router comprising an Internet group management protocol (IGMP) proxy, an IGMP snooping, a driver and a switch application specific integrated circuit (ASIC), the switch ASIC comprising a wide area network (WAN) interface, a wired interface, a wireless interface, and a switch circuit, the wired interface corresponding to one or more communication ports, the datagram multicasting method comprising:
the IGMP proxy establishing a multicasting table comprising multicast addresses and corresponding interfaces, wherein the corresponding interfaces comprise the wired interface and the wireless interface;
the IGMP snooping establishing a switching table comprising the multicast addresses and corresponding ports;
the WAN interface receiving a multicast datagram comprising a multicast address from the multicast server and sending the multicast datagram to the switch circuit and the driver;
the switch circuit obtaining ports corresponding to the multicast address of the multicast datagram according to the switching table;
the switch circuit distributing the multicast datagram to the obtained ports;
the driver obtaining interfaces corresponding to the multicast address of the multicast datagram according to the multicasting table;
the driver determining if one of the obtained interfaces is the wireless interface;
the driver discarding the multicast datagram if all the obtained interfaces are the wired interface; or
the driver multicasting the multicast datagram to the wireless interface if one of the obtained interfaces is the wireless interface.

5. The method as claimed in claim 4, further comprising the switch circuit discarding the multicast datagram if the switch circuit cannot obtain ports corresponding to the multicast address of the multicast datagram according to the switching table.

6. The method as claimed in claim 4, further comprising the driver discarding the multicast datagram if the driver cannot obtain interfaces corresponding to the multicast address of the multicast datagram according to the multicasting table.
